(19) United States
(12) Patent Application Publication
(10) Pub. No.: US 2020/0233676 A1
(43) Pub. Date: Jul. 23, 2020

(54) BIOS MANAGEMENT DEVICE, BIOS MANAGEMENT SYSTEM, BIOS MANAGEMENT METHOD, AND BIOS MANAGEMENT PROGRAM-STORED RECORDING MEDIUM

(71) Applicant: NEC Platforms, Ltd., Kawasaki-shi, Kanagawa (JP)

(72) Inventor: Masahiro JINDO, Kanagawa (JP)

(73) Assignee: NEC Platforms, Ltd., Kawasaki-shi, Kanagawa (JP)

(21) Appl. No.: 16/647,580

(22) PCT Filed: Sep. 18, 2018
(86) PCT No.: PCT/JP2018/034355

§ 371 Date: Mar. 16, 2020

(30) Foreign Application Priority Data
Sep. 20, 2017 (JP) 2017-180250

(51) Int. Cl. G06F 9/4401; G06F 21/60

(52) U.S. Cl. CPC G06F 9/4406; G06F 21/602

(57) ABSTRACT

A BIOS management device includes: a storage unit storing original BIOS information used as original information of BIOS information referred to by an information processing device when the BIOS information is stored in the information processing device; an operation unit executing, on the BIOS information and the original BIOS information, operation processing that varies each time the information processing device is activated; a comparison unit comparing a first result of the operation processing executed on the BIOS information with a second result of the operation processing executed on the original BIOS information; and a control unit controlling the information processing device in such a way as to execute the BIOS information and thereby complete activation, when the first and second results match each other, whereby BIOS robustness against illicit alteration is strengthened.

### TECHNICAL FIELD

The present invention relates to a technique of verifying authenticity of a basic input output system (BIOS).

### BACKGROUND ART

When a BIOS being a program activating an information processing device such as a server device and controlling overall operation during the activation and after the activation is illicitly altered by malware or the like, there is a possibility of occurrence of a serious security problem such as a leak of confidential information unknowingly by a user. Accordingly, there is an increasing expectation for a technique of protecting a BIOS from illicit alteration and verifying authenticity of the BIOS to be used by the information processing device at the time of the activation.

As a technique related to such a technique, PTL 1 discloses a system that protects information stored in a server or a personal computer, via a secure boot process. The system includes a controller separated from a processor in terms of processing and storing of information, and the controller includes an encryption service module. In the system, encrypted information is communicated between the controller and the processor in order to verify authenticity of firmware.

PTL 2 discloses a BIOS chip that verifies an input modification command from an external device, and then, gives permission to modify internal BIOS data. The BIOS chip includes a first flash memory unit that holds the internal BIOS data, a second flash memory unit that holds security data, and an integrated code management device that is connected to the external device, the first flash memory unit, and the second flash memory unit. The integrated code management device receives a modification command, and stores the security data in the second flash memory unit. The integrated code management device generates encrypted data acquired by encrypting the security data, and transmits the encrypted data to the external device that performs decryption. In the BIOS chip, the decrypted data decrypted by the external device are returned to the integrated code management device for comparison with the original security data. Then, when the decrypted data match the security data, the BIOS chip gives permission of replacing the internal BIOS data with data provided from the external device.

PTL 3 discloses an information processing terminal that detects a checksum error at the time of making an activation by executing a BIOS. When detecting the checksum error, the information processing terminal automatically initializes settings of the BIOS, and makes a re-activation by automatically re-executing the BIOS when the initialization is completed.

### CITATION LIST

### Patent Literature

[PTL 1] Japanese Unexamined Patent Application Publication No. 2011-243231

[PTL 2] Japanese Unexamined Patent Application Publication No. 2002-55725

[PTL 3] Japanese Unexamined Patent Application Publication No. 2011-81617

### SUMMARY OF INVENTION

### Technical Problem

In order to guarantee authenticity of a BIOS to be used when an information processing device is activated, a check program stored in a mask read only memory (ROM) or the like checks authenticity of the BIOS at the time of the activation, for example. Alternatively, a trusted platform module (TPM) being dedicated hardware for security check is mounted, and authenticity of a BIOS is checked by using a hash value that is stored in the TPM and is acquired from the authentic BIOS.

However, there is a case where malware or the like having an advanced alteration function disguises data used for the above-described check not as data acquired from an altered BIOS but as a value acquired from an authentic BIOS, for example, and thereby cleverly passes through the check. Thus, it is a problem to strengthen robustness against illicit alteration of a BIOS in such a way that the BIOS can be protected from the malware having such an advanced alteration function. The techniques described in PTLs 1 to 3 are not sufficient to solve such a problem. A main object of the present invention is to provide a BIOS management device and the like that solve the problem.

### Solution to Problem

A BIOS management device according to one aspect of the present invention includes: a storage means for storing original basic-input-output-system (BIOS) information used as original information of BIOS information referred to by an information processing device when the BIOS information is stored in the information processing device; an operation means for executing, on the BIOS information and the original BIOS information, operation processing that varies each time the information processing device is activated; a comparison means for comparing a first result of the operation processing executed on the BIOS information with a second result of the operation processing executed on the original BIOS information; and a control means for, when the first and second results match each other, controlling the information processing device in such a way as to complete activation by executing the BIOS information.

At another standpoint for accomplishing the above-described object, a BIOS management method according to one aspect of the present invention includes, in a case where a storage means stores original BIOS information used as original information of BIOS information referred to by a first information processing device when the BIOS information is stored in the first information processing device, by a second information processing device: executing, on the BIOS information and the original BIOS information, operation processing that varies each time the first information processing device is activated; comparing a first result of the operation processing executed on the BIOS information with a second result of the operation processing executed on the original BIOS information; and, when the first and second results match each other, controlling the first information processing device in such a way as to complete activation by executing the BIOS information.

At still another standpoint for accomplishing the above-described object, a BIOS management program according to one aspect of the present invention causes a computer to execute, in a case where the computer is able to access a storage means for storing original BIOS information used as original information of BIOS information referred to by an information processing device when the BIOS information is stored in the information processing device: an operation function of executing, on the BIOS information and the original BIOS information, operation processing that varies each time the information processing device is activated; a comparison function of comparing a first result of the operation processing executed on the BIOS information with a second result of the operation processing executed on the original BIOS information; and a control function of, when the first and second results match each other, controlling the information processing device in such a way as to complete activation by executing the BIOS information.

Further, the present invention can be achieved also by a computer-readable non-volatile recording medium that stores the BIOS management program (computer program).

### Advantageous Effects of Invention

The present invention can strengthen robustness against illicit alteration of a BIOS.

### BRIEF DESCRIPTION OF DRAWINGS

FIG. 1 is a block diagram conceptually illustrating a configuration of a BIOS management system 1 according to a first example embodiment of the present invention.

FIG. 2A is a flowchart (1/2) illustrating operation of the BIOS management system 1 according to the first example embodiment of the present invention.

FIG. 2B is a flowchart (2/2) illustrating operation of the BIOS management system 1 according to the first example embodiment of the present invention.

FIG. 3 is a block diagram conceptually illustrating a configuration of a BIOS management device 30 according to a second example embodiment of the present invention.

FIG. 4 is a block diagram illustrating a configuration of an information processing device 900 that can implement the BIOS management device according to each of the example embodiments of the present invention.

### EXAMPLE EMBODIMENT

Hereinafter, example embodiments of the present invention are described in detail with reference to the drawings.

### First Example Embodiment

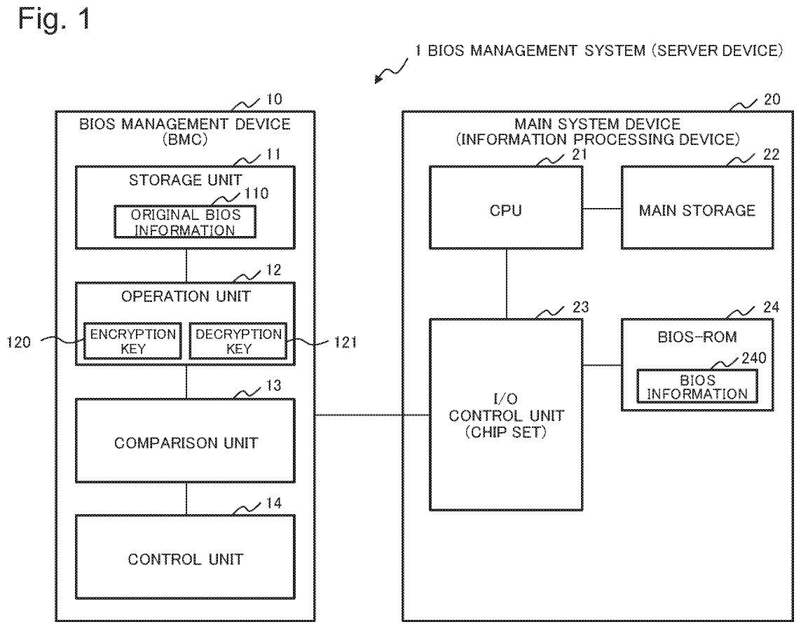

FIG. 1 is a block diagram conceptually illustrating a configuration of a BIOS management system 1 according to a first example embodiment of the present invention. The BIOS management system 1 includes a BIOS management device 10 and a main system device (information processing device) 20 in rough classification. The BIOS management system 1 may be configured as one server device, for example.

The main system device 20 is a device that provides various kinds of service by executing various applications (software). The main system device 20 includes a central processing unit (CPU) 21, a main storage 22, an input-output (I/O) control unit (chip set) 23, and a BIOS-ROM 24. When the BIOS management system 1 is turned on, the CPU 21 reads, via the I/O control unit 23, BIOS information 240 stored in the BIOS-ROM 24. Then, the CPU 21 refers to and executes the read BIOS information 240, and thereby performs processing of activating the main system device 20. The BIOS-ROM 24 is a flash ROM as a rewritable and non-volatile memory, for example.

The BIOS management device (BMC: baseboard management controller) 10 performs control on the main system device 20, concerning an operating environment, failure processing, and the like. The BIOS management device 10 includes a function of controlling an execution start and an execution stop of the BIOS information 240, accompanying power-on and power-off of the BIOS management system 1. The BIOS management device 10 includes a function of controlling input and output of information with a console terminal (not illustrated) when a user monitors a state of the BIOS management system 1 by using the console terminal. The BIOS management device 10 also includes a function of controlling storing of the BIOS information 240 in the BIOS-ROM 24 (controlling updating of the BIOS information 240).

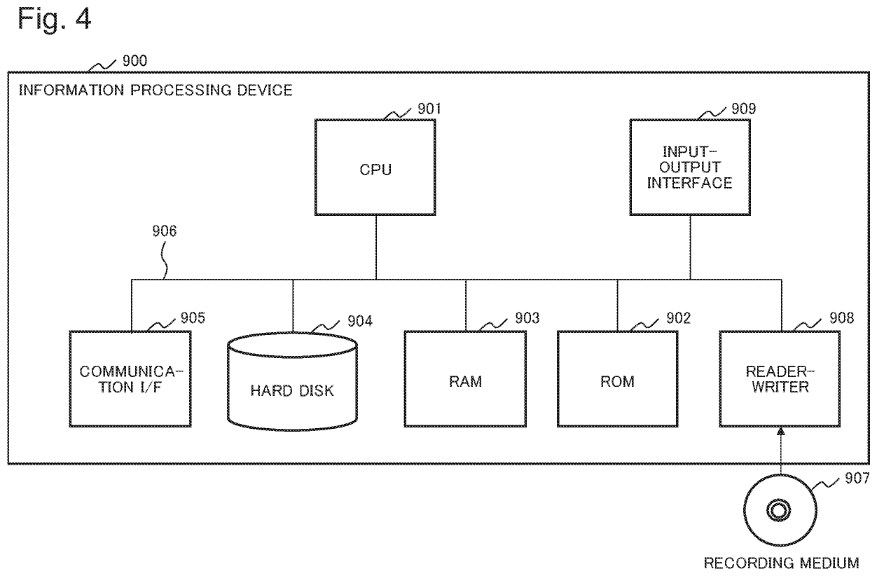

The BIOS management device 10 includes a storage unit 11, an operation unit 12, a comparison unit 13, and a control unit 14. A storing control function in the storage unit 11, the operation unit 12, the comparison unit 13, and the control unit 14 may be installed for example in BMC firmware that implements the above-described functions of the BIOS management device 10, as described below concerning a hardware configuration example of the BIOS management device 10 with reference to FIG. 4.

The storage unit 11 is a non-volatile storage device such as a non-volatile memory. The storage unit 11 stores original BIOS information 110. The original BIOS information 110 is original information stored as the BIOS information 240 into the BIOS-ROM 24 in the main system device 20.

For example, the BIOS management device 10 acquires the original BIOS information 110, via an input-output interface 909 illustrated in FIG. 4, from an external device connected to a communication network. Alternatively, the storage unit 11 acquires the original BIOS information 110 via a recording medium (update medium) 907 illustrated in FIG. 4. The recording medium 907 includes a header area where attached information and the like concerning the original BIOS information 110 is stored, in addition to a storage area where the original BIOS information 110 is stored.

The operation unit 12 includes a function of executing, on the BIOS information 240 and the original BIOS information 110, operation processing that varies each time the main system device 20 starts to be activated by turning on the BIOS management system 1.

More specifically, the operation unit 12 generates a random number based on the time that the main system device 20 is activated, for example. Herein, it is assumed that the operation unit 12 includes a device (not illustrated) including a time measurement function such as a clock. Then, by using the generated random number, the operation unit 12 generates an encryption key 120 and a decryption key 121 that vary each time the main system device 20 starts to be activated. For the generation of the encryption key 120 and the decryption key 121, an existing technique such as the Rivest-Shamir-Adleman cryptosystem (RSA) can be used, and thus, the detailed description is omitted in the present application.

By using the generated encryption key 120, the operation unit 12 encrypts the original BIOS information 110 stored in the storage unit 11. The operation unit 12 transmits the generated encryption key 120 to the main system device 20, and controls the main system device 20 in such a way as to encrypt, with the encryption key 120, the BIOS information 240 stored in the BIOS-ROM 24. By using the generated decryption key 121, the operation unit 12 decrypts the original BIOS information 110 and the BIOS information 240 encrypted with the encryption key 120.

The comparison unit 13 confirms whether a result (first result) of decryption performed on the BIOS information 240 by the operation unit 12 matches a result (second result) of decryption performed on the original BIOS information 110 by the operation unit 12. The comparison unit 13 inputs this comparison result into the control unit 14.

When the comparison result input from the comparison unit 13 indicates that the first and second results match each other, the control unit 14 determines that the BIOS information 240 stored in the BIOS-ROM 24 is authentic BIOS information not having been altered by malware or the like. In this case, the control unit 14 controls the main system device 20 in such a way as to complete the activation by executing the BIOS information 240.

When the comparison result input from the comparison unit 13 indicates that the first and second results do not match each other, the control unit 14 determines that the BIOS information 240 stored in the BIOS-ROM 24 is illicit BIOS information having a possibility of having been altered by malware or the like. In this case, the control unit 14 controls the main system device 20 in such a way as to stop the activation performed by the BIOS information 240.

In this case, the control unit 14 may update the BIOS information 240 having a possibility of having been altered, to be authentic BIOS information, and may control the main system device 20 in such a way as to execute the updated BIOS information 240 and thereby complete the activation. In other words, the control unit 14 updates the BIOS information 240 stored in the BIOS-ROM 24, to be the original BIOS information 110 stored in the storage unit 11. Then, the control unit 14 controls the main system device 20 in such a way as to execute the BIOS information 240 having been updated to be the original BIOS information 110 and thereby complete the activation.

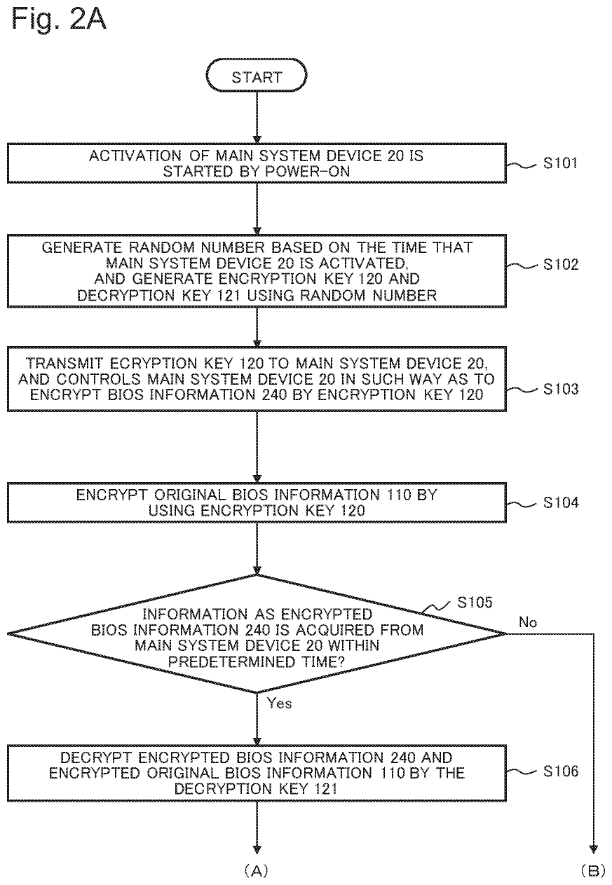

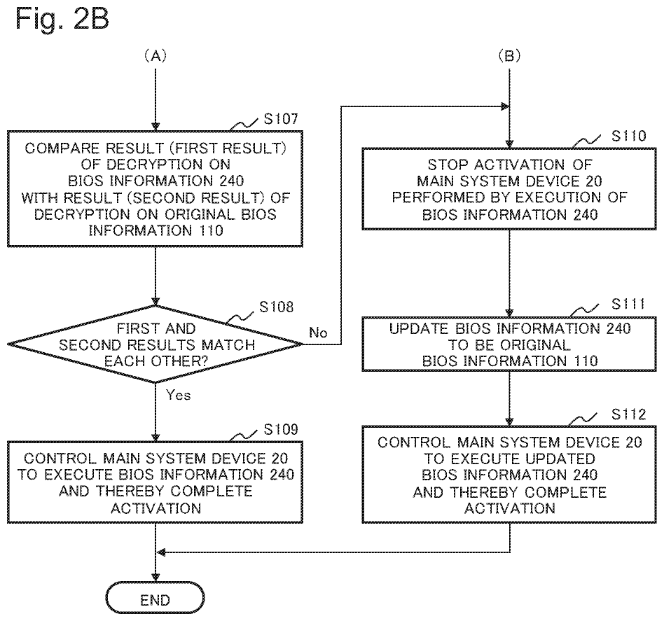

Next, operation (processing) of the BIOS management system 1 according to the present example embodiment is described in detail with reference to flowcharts of FIG. 2A and FIG. 2B.

When the BIOS management system 1 is turned on by a user, for example, the main system device 20 starts to be activated (a step S101). The operation unit 12 generates a random number based on a time when the main system device 20 is activated, and generates an encryption key 120 and a decryption key 121 by using the generated random number (a step S102).

The operation unit 12 transmits the generated encryption key 120 to the main system device 20, and controls the main system device 20 in such a way as to encrypt the BIOS information 240 by the encryption key 120 (a step S103). The operation unit 12 encrypts the original BIOS information 110 by using the encryption key 120 (a step S104).

When the operation unit 12 does not acquire information as the encrypted BIOS information 240 from the main system device 20 within predetermined time (no at a step S105), the processing proceeds to a step S110. When the operation unit 12 acquires information as the encrypted BIOS information 240 from the main system device 20 within the predetermined time (yes at a step S105), the operation unit 12 decrypts the encrypted BIOS information 240 and the encrypted original BIOS information 110 by the generated decryption key 121 (a step S106).

The comparison unit 13 compares a result (first result) of the decryption performed on the BIOS information 240 with a result (second result) of the decryption performed on the original BIOS information 110 (a step S107). When the first and second results match each other (yes at a step S108), the control unit 14 controls the main system device 20 in such a way as to execute the BIOS information 240 stored in the BIOS-ROM 24 and thereby complete the activation (a step S109), and the entire processing is ended.

When the first and second results do not match each other (no at a step S108), the control unit 14 stops the activation of the main system device 20 performed by execution of the BIOS information 240 (step S110). The control unit 14 updates the BIOS information 240 stored in the BIOS-ROM 24, to be the original BIOS information 110 stored in the storage unit 11 (a step S111). The control unit 14 controls the main system device 20 in such a way as to complete the activation by executing the BIOS information 240 having been updated to be the original BIOS information 110 (a step S112), and the entire processing is ended.

The BIOS management device 10 according to the present example embodiment can strengthen robustness against illicit alteration of the BIOS. The reason is that the BIOS management device 10 executes, on the BIOS information 240 and the original BIOS information 110, the operation processing that varies each time the main system device 20 is activated, and when two results of the operation processing match each other, the BIOS management device 10 controls the main system device 20 in such a way as to execute the BIOS information 240 and thereby complete the activation.

Hereinafter, advantageous effects achieved by the BIOS management device 10 according to the present example embodiment are described in detail.

In order to guarantee authenticity of a BIOS used when the information processing device is activated, at the time of the activation, for example, authenticity of the BIOS is checked by a check program. Alternatively, a TPM is mounted, and authenticity of a BIOS is checked by using a hash value stored in the TPM and acquired from the authentic BIOS. However, there is a case where malware or the like having an advanced alteration function disguises data used for the above-described check not as data acquired from an altered BIOS but as a value acquired from an authentic BIOS, for example, and thereby cleverly pass through the check.

For example, in the example illustrated in FIG. 1, the BIOS information 240 matches the original BIOS information 110, it can be guaranteed that the BIOS information 240 is authentic BIOS information not having been illicitly altered. In this case, simple comparison of the BIOS information 240 with the original BIOS information 110 is not sufficient to guarantee that the BIOS information 240 is authentic BIOS information. This is because there is a possibility that when the BIOS information 240 is read from the BIOS-ROM 24, malware that has altered the BIOS information 240 makes disguise in such a way that the BIOS information 240 is read from the BIOS-ROM 24 in a state before the BIOS information 240 is altered.

Performing predetermined operation processing (e.g., encryption processing and decryption processing) on the BIOS information 240 and the original BIOS information 110 can make it difficult that malware having illicitly altered the BIOS information 240 makes the above-described disguise. However, when contents of the operation processing are fixed, there is a possibility that the malware makes disguise relevant to the operation processing. Thus, it is a problem to strengthen robustness against illicit alteration of a BIOS in such a way that the BIOS can be protected from the malware including such advanced alteration function and disguise function.

For such a problem, the BIOS management device 10 according to the present example embodiment includes the storage unit 11, the operation unit 12, the comparison unit 13, and the control unit 14, and operates, for example, as described above with reference to FIG. 1 to FIG. 3. In other words, the storage unit 11 stores the original BIOS information 110 used as the original information of the BIOS information 240 when the BIOS information 240 referred to by the main system device (information processing device) 20 is stored in the main system device 20. The operation unit 12 executes, on the BIOS information 240 and the original BIOS information 11, operation processing (e.g., encryption processing and decryption processing) that varies each time the main system device 20 is activated. The comparison unit 13 compares a first result of the operation processing performed on the BIOS information 240 with a second result of the operation processing performed on the original BIOS information 110. Then, when the first and second results match each other, the control unit 14 controls the main system device 20 in such a way as to execute the BIOS information 240 and thereby complete the activation.

In other words, contents of the operation processing that the BIOS management device 10 according to the present example embodiment performs on the BIOS information 240 and the original BIOS information 110 vary each time the main system device 20 is activated. For this reason, it becomes very difficult that malware having illicitly altered the BIOS information 240 makes disguise relevant to the operation processing thus varying each time. Accordingly, the BIOS management device 10 according to the present example embodiment can strengthen robustness against illicit alteration of a BIOS.

The operation processing that the operation unit 12 according to the present example embodiment performs on the BIOS information 240 and the original BIOS information 110 is not limited to encryption processing and decryption processing. For example, by using a random number based on a time when the main system device 20 is activated, the operation unit 12 generates a hash function that varies each time the main system device 20 is activated. Then, by using the generated hash function, the operation unit 12 may acquire a hash value concerning the BIOS information 240 and the original BIOS information 110.

When detecting that the BIOS information 240 has been illicitly altered, the BIOS management device 10 according to the present example embodiment stops the activation of the main system device 20 performed by execution of the BIOS information 240. Then, the BIOS management device 10 can control the main system device 20 in such a way as to update the altered BIOS information 240 to be the original BIOS information 110, and execute the updated BIOS information 240 and thereby complete the activation. Accordingly, the BIOS management device 10 according to the present example embodiment automatically performs the work of recovering the altered BIOS information 240, and thus can reduce a burden on a user, and can shorten time required for the recovery.

### Second Example Embodiment

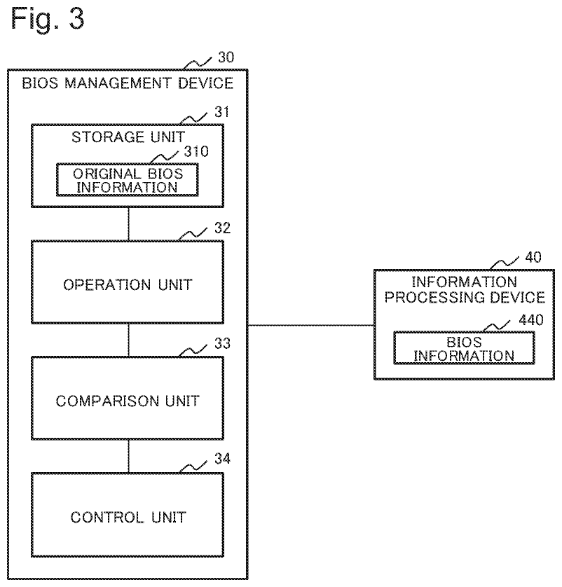

FIG. 3 is a block diagram conceptually illustrating a configuration of a BIOS management device 30 according to a second example embodiment of the present invention.

The BIOS management device 30 according to the example embodiment includes a storage unit 31, an operation unit 32, a comparison unit 33, and a control unit 34.

The storage unit 31 stores original BIOS information 310 used as original information of BIOS information 440 when the BIOS information 440 referred to by an information processing device is stored in the information processing device 40.

The operation unit 32 executes, on the BIOS information 440 and the original BIOS information 310, operation processing that varies each time the information processing device 40 is activated.

The comparison unit 33 compares a first result of the operation processing executed on the BIOS information 440 with a second result of the operation processing executed on the original BIOS information 310.

When the first and second results match each other, the control unit 34 controls the information processing device 40 in such a way as to execute the BIOS information 440 and thereby complete the activation.

The BIOS management device 30 according to the present example embodiment can strengthen robustness against illicit alteration of a BIOS. The reason is that the BIOS management device 30 executes, on the BIOS information 440 and the original BIOS information 310, the operation processing that varies each time the information processing device 40 is activated, and when two results of the operation processing match each other, the BIOS management device 30 controls the information processing device 40 in such a way as to execute the BIOS information 440 and thereby complete the activation.

### <Hardware Configuration Example>

In each of the above-described example embodiments, each unit in the BIOS management devices illustrated in FIG. 1 and FIG. 3 can be implemented by dedicated hardware (HW) (an electronic circuit). In FIG. 1 and FIG. 3, at least the following constituents can be regarded as function (processing) units (software modules) of a software program.
The storage control functions in the storage units 11 and 31
The operation units 12 and 32
The comparison units 13 and 33
The control units 14 and 34

However, the division of each unit illustrated in these drawings is a constituent for convenience of the description, and various constituents can be expected for installation. The following describes one example of a hardware environment in this case, with reference to FIG. 4.

FIG. 4 is a diagram exemplarily illustrating a configuration of an information processing device 900 (a computer) that can implement the BIOS management device according to each example embodiment of the present invention. In other words, FIG. 4 illustrates a configuration of a computer (information processing device) that can implement the BIOS management devices illustrated in FIG. 1 and FIG. 3, i.e., illustrates a hardware environment that can implement each function in the above-described example embodiments.

The information processing device 900 illustrated in FIG. 4 includes the following constituent elements.
A central processing unit (CPU) 901
A read only memory (ROM) 902
A random access memory (RAM) 903
A hard disk (storage device) 904
A communication interface 905 with an external device
A bus 906 (a communication line)
A reader-writer 908 capable of reading and writing data stored in a recording medium 907 such as a compact disc read only memory (CD-ROM)
An input-output interface 909

In other words, the information processing device 900 including the above-described constituent elements is a general computer in which these constituent elements are connected to each other via the bus 906. The information processing device 900 includes a plurality of the CPUs 901 in one case, or includes the CPU 901 constituted by a multi-core in another case.

The present invention described above by citing the above example embodiments as examples provides, to the information processing device 900 illustrated in FIG. 4, a computer program that can implement the following functions. The functions are the functions of the above-described configurations in the block configuration diagrams (FIG. 1 and FIG. 3) referred to in the description of the example embodiments or the flowcharts (FIG. 2A and FIG. 2B). The present invention is implemented by then reading the computer program to the CPU 901 of the hardware, and interpreting and executing the program. The computer program provided in the device may be stored in a readable and writable volatile memory (RAM 903) or a nonvolatile storage device such as the ROM 902 or the hard disk 904.

In the above case, at present, a general procedure can be adopted as a method of providing the computer program into the hardware. Examples of the procedure includes a method of installing in the device via various recording media 907 such as a CD-ROM, and a method of downloading from an outside via a communication line such as the Internet. In such a case, the present invention can be regarded as being configured by codes constituting the computer program or by the recording medium 907 in which the codes are stored.

The present invention has been particularly shown and described above by citing the above-described example embodiments thereof as model examples. However, the present invention is not limited to these example embodiments. In other words, it will be understood by those of ordinary skill in the art that various modes may be made in the present invention without departing from the spirit and scope of the present invention as defined by the claims.

This application is based upon and claims the benefit of priority from Japanese patent application No. 2017-180250, filed on Sep. 20, 2017, the disclosure of which is incorporated herein in its entirety by reference.

### REFERENCE SIGNS LIST

1 BIOS management system
10 BIOS management device
11 Storage unit
110 Original BIOS information
12 Operation unit
120 Encryption key
121 Decryption key
13 Comparison unit
14 Control unit
20 Main system device
21 CPU
22 Main storage
23 I/O control unit
24 BIOS-ROM
240 BIOS information
30 BIOS management device
31 Storage unit
310 Original BIOS information
32 Operation unit
33 Comparison unit
34 Control unit
40 Information processing device
440 BIOS information
900 Information processing device
901 CPU
902 ROM
903 RAM
904 hard disk (storage device)
905 Communication interface
906 Bus
907 Recording medium
908 Reader-writer
909 Input-output interface

What is claimed is:

1. A BIOS management system, comprising:
at least one memory storing a computer program, and
original basic-input-output-system (BIOS) information used as original information of BIOS information referred to by an information processing device when the BIOS information is stored in the information processing device; and
at least one processor configured to execute the computer program to:
execute, on the BIOS information and the original BIOS information, operation processing that varies each time the information processing device is activated;
compare a first result of the operation processing executed on the BIOS information with a second result of the operation processing executed on the original BIOS information; and
when the first and second results match each other, control the information processing device in such a way as to complete activation by executing the BIOS information.

2. The BIOS management system according to claim 1, wherein the processor is configured to execute the computer program to
generate an encryption key and a decryption key that vary each time the information processing device is activated, then execute encryption on the BIOS information and the original BIOS information by using the encryption key being generated, and execute decryption on the BIOS information being encrypted and the original BIOS information being encrypted by using the decryption key.

3. The BIOS management system according to claim 1, wherein the processor is configured to execute the computer program to
generate a hash function that varies each time the information processing device is activated, and then acquire a hash value concerning the BIOS information and the original BIOS information, by using the hash function being generated.

4. The BIOS management system according to claim 1, wherein the processor is configured to execute the computer program to
generate a random number based on a time when the information processing device is activated, and execute the operation processing that uses the random number being generated.

5. The BIOS management system according to claim 1, wherein the processor is configured to execute the computer program to,
when the first and second results do not match each other, stop the activation of the information processing device.

6. The BIOS management system according to claim 1, wherein the processor is configured to execute the computer program to,
when the first and second results do not match each other, update the BIOS information to be the original BIOS information stored in the memory, and then control the information processing device in such a way as to execute the BIOS information being updated.

7. A BIOS management system
according to claim 1 further comprising
the information processing device.

8. The BIOS management system according to claim 7, wherein the processor is configured to execute the computer program to
control the information processing device in such a way as to execute the operation processing on the BIOS information, and
the information processing device inputs, into the processor, a result acquired by executing the operation processing.

9. A BIOS management method comprising, in a case where a memory stores original BIOS information used as original information of BIOS information referred to by a first information processing device when the BIOS information is stored in the first information processing device,
by a second information processing device:
executing, on the BIOS information and the original BIOS information, operation processing that varies each time the first information processing device is activated;
comparing a first result of the operation processing executed on the BIOS information with a second result of the operation processing executed on the original BIOS information; and,
when the first and second results match each other, controlling the first information processing device in such a way as to complete activation by executing the BIOS information.

10. A non-transitory computer-readable recording medium storing a BIOS management program that causes a computer to execute, in a case where the computer is able to access a memory storing original BIOS information used as original information of BIOS information referred to by an information processing device when the BIOS information is stored in the information processing device:
executing, on the BIOS information and the original BIOS information, operation processing that varies each time the information processing device is activated;
comparing a first result of the operation processing executed on the BIOS information with a second result of the operation processing executed on the original BIOS information; and
when the first and second results match each other, controlling the information processing device in such a way as to complete activation by executing the BIOS information.
